(19) United States
(12) Patent Application Publication
(10) Pub. No.: US 2020/0282536 A1
(43) Pub. Date: Sep. 10, 2020

(54) FUEL-POWERED SETTING DEVICE AND METHOD FOR OPERATING SUCH A SETTING DEVICE

(71) Applicant: Hilti Aktiengesellschaft, Schaan (LI)

(72) Inventors: Dominik SCHMIDT, Buchs (CH); Iwan WOLF, Untervaz (CH); Tilo DITTRICH, Feldkirch (AT); Peter BRUGGMUELLER, Bludesch (AT); Norbert HEEB, Buchs (CH)

(21) Appl. No.: 16/063,829

(22) PCT Filed: Dec. 20, 2016
(86) PCT No.: PCT/EP2016/081916

§ 371 Date: Jun. 19, 2018

(30) Foreign Application Priority Data
Dec. 22, 2015 (EP) 15201892.5

(51) Int. Cl. B25C 1/08

(52) U.S. Cl. CPC B25C 1/08; F02B 63/02

(57) ABSTRACT

The invention relates to a fuel-powered setting device for driving securing elements into a substrate, comprising at least one main combustion chamber for a fuel, a drive piston that can be driven out of the main combustion chamber in a setting direction by expandable gases, and a prechamber with which an ignition arrangement is associated and in which a pressure acting on the main combustion chamber can build up prior to a fuel-air mixture being ignited in said main combustion chamber, wherein the prechamber is or can be connected to surroundings of the prechamber via at least one passage opening able to be closed by a control device. To improve the efficiency and/or functionality when driving in securing elements, the control device comprises an electronic control unit.

### TECHNICAL FIELD

The present invention relates to a combustion-powered setting tool for driving fastening elements into a substrate, having at least one main combustion chamber for a fuel, having a drive piston actuatable by way of expandable gases from the main combustion chamber in the setting direction, and having a prechamber, to which an ignition device is assigned and in which a pressure acting on the main combustion chamber is buildable before the ignition of a fuel-air mixture in the main combustion chamber, the prechamber being connected or connectable to the surroundings of the prechamber by at least one passage opening, which is closeable by a control device. The present invention further relates to a method for operating such a combustion-powered setting tool.

### BACKGROUND OF THE INVENTION

German patent publication DE 10 32 035 A1 discloses a combustion-powered setting tool for driving fastening elements into a substrate, which has at least one main combustion chamber for a fuel, one drive piston mounted in a piston guide actuatable in the setting direction by way of expandable gases from the main combustion chamber, and which has a prechamber, in which a pressure acting on the main combustion chamber is buildable prior to the ignition of a fuel-air mixture in the main combustion chamber, the prechamber being formed within the piston guide by a space connecting to the bottom side of the drive piston, which is in its initial position, facing away from the main combustion chamber, and the prechamber at least temporarily being connected via a passage opening to the main combustion chamber, and in the main combustion chamber a means for detecting the pressure being provided, which acts together with the ignition device for the main combustion chamber.

### SUMMARY OF THE INVENTION

The object of the present invention is to improve the effectiveness and/or functionality when in-driving fastening elements using a combustion-powered setting tool, having at least one main combustion chamber for a fuel, having a drive piston actuatable by way of expandable gases from the main combustion chamber in the setting direction, and having a prechamber, to which an ignition device is assigned and in which a pressure acting on the main combustion chamber is buildable prior to the ignition of a fuel-air mixture in the main combustion chamber, the prechamber being connected or connectable to the surroundings of the prechamber by at least one passage opening, which is closeable by a control device.

The object of the present invention for a combustion-powered setting tool for driving fastening elements into a substrate, having at least one main combustion chamber for a fuel, having a drive piston actuatable in the setting direction by way of expandable gases from the main combustion chamber, and having a prechamber, to which an ignition device is assigned and in which a pressure acting on the main combustion chamber is buildable prior to the ignition of a fuel-air mixture in the main combustion chamber, the prechamber being connected or connectable to the surroundings of the prechamber by at least one passage opening, which is closeable by a control device, is achieved in that the control device includes an electronic controller. Undesireable frictional losses during operation of the combustion-powered setting tool can be significantly reduced by the use of the electronic controller for closing or releasing the passage opening of the prechamber. As a result, the service life of the combustion-powered setting tool can be extended.

A further preferred exemplary embodiment of the combustion-powered setting tool is characterized by the fact that the electronic controller is connected to an electronic actuator. Via the electric actuator, the passage opening of the prechamber can be quickly closed or released in a simple manner.

A further preferred exemplary embodiment of the combustion-powered setting tool is characterized by the fact that the electric actuator includes an electric motor. Via the electronic controller, the electric motor can be actuated in a fast and simple manner. For the representation of the electric actuator, the electric motor, for example, is mounted on the outside of a housing, in particular a prechamber cylinder.

A further preferred exemplary embodiment of the combustion-powered setting tool is characterized by the fact that the electric actuator is mechanically coupled to a control sleeve. The mechanical coupling between the electric actuator and the control sleeve includes, for example, a type of gear mechanism. For example, the control sleeve substantially has the shape of a circular cylinder jacket, which relative to a housing, in particular the prechamber cylinder delimiting the prechamber, is moveable between an open position, in which the passage opening is released or open, and a closed position, in which the passage opening of the prechamber is released.

A further preferred exemplary embodiment of the combustion-powered setting tool is characterized by the fact that the control sleeve has a toothing, which is coupled to the electric actuator via a gear wheel. For example, the toothing can be provided at a toothed rod, which is fastened to the outside of the control sleeve. Advantageously, the gear wheel using the toothing meshes with the toothed rod. In so doing, a gear mechanism can be embodied in a simple manner, via which the control sleeve can be moved by the electric motor, which is actuated by the electronic controller.

A further preferred exemplary embodiment of the combustion-powered setting tool is characterized by the fact that the control sleeve is configured in such a manner that, and is moveable in relation to the passage opening of the prechamber so that the passage opening of the prechamber is released or closed by the control sleeve via the electronic controller by way of the electric actuator. For example, the movement of the control sleeve between the open position and the closed position is enabled by guiding the control sleeve at the housing or the prechamber cylinder delimiting the prechamber. Given a complete overlapping between a passage opening in the control sleeve and the passage opening of the prechamber, a passage cross section or outlet cross section of the prechamber is maximized. In the closed position, the passage opening of the prechamber preferably is completely closed by the control sleeve. Via the electronic controller, any intermediate positions of the control sleeve can be represented in a simple manner. Thus, with the aid of the electronic controller and the electric actuator, the passage cross section can be infinitely varied between the open position and the closed position. In so doing, particularly advantageously a power adjustment or setting becomes possible during operation of the setting tool.

A further preferred exemplary embodiment of the combustion-powered setting tool is characterized by the fact that the electronic controller is connected to at least one sensor device, which is assigned to the main combustion chamber. The sensor device, for example, can be a pressure sensor, which detects a pressure in the main combustion chamber. The signal of the pressure sensor is processed in the electronic controller of the control device. The sensor device can include further sensors, which detect an ambient pressure, a pressure in the prechamber, an acceleration of the setting tool and/or a temperature at any location of the setting tool, for example.

According to a further exemplary embodiment, the electronic controller of the control device can have a user interface. Via the user interface, the user of the setting tool can individually modify or adjust a power setting.

A further preferred exemplary embodiment of the combustion-powered setting tool is characterized by the fact that the electronic controller is connected to the ignition device, which is assigned to the prechamber. As a result, a time-oriented sequential control can be enabled in a simple manner during operation of the combustion-powered setting tool. Opening and closing the passage opening of the prechamber can be carried out in a time-controlled manner after a specific period of time has elapsed following an ignition in the prechamber. For this purpose, for example a time interval, which begins with the ignition in the prechamber, is measured in the electronic controller of the control device. According to the previously set time interval, the electric actuator for opening the passage opening of the prechamber can, also via the electronic controller, be then automatically activated with the aid of the control sleeve.

A further preferred exemplary embodiment of the combustion-powered setting tool is characterized by the fact that a further ignition device is assigned to the main combustion chamber. The setting tool previously described can be operated by only one ignition device assigned to the prechamber. Following an ignition in the prechamber, the reaction gases from the prechamber expand into the main combustion chamber having a spreading flame front. Via the flame front spreading into the main combustion chamber, the ignition of a pre-compressed fuel-air mixture included in the main combustion chamber then occurs in the main combustion chamber. The ignition of the fuel-air mixture in the main combustion chamber may however also take place via the further ignition device in the main combustion chamber.

In a method for operating a combustion-powered setting tool described previously, the above indicated object is alternatively or additionally achieved in that the control of the passage opening of the prechamber is carried out by the main combustion chamber pressure. In so doing, a combustion-powered or gas-powered setting tool, which has a substantially higher energy density, can be implemented in a simple manner. The previously described measures enable to control a ventilation of the prechamber in a particularly simple manner. For this purpose, an undesirable wear of the setting tool when in use may be reduced. Moreover, by controlling the passage opening of the prechamber by the main combustion chamber pressure, a significantly increased service life of the setting tool can be ensured.

A preferred exemplary embodiment of the method is characterized by the fact that the control of the passage opening of the prechamber is carried out as a function of the ignition time and the sensor. In so doing, the control of a prechamber ventilation when operating the combustion-powered setting tool can be implemented in a simple manner.

Optionally, the present invention also relates to a computer program product having a program code for carrying out a previously-described method, in particular if the program is executed in the control of the setting tool.

The present invention further relates to a control device, in particular an electronic controller, an electric actuator and/or a control sleeve for a previously-described setting tool. The mentioned parts are optionally separately negotiable.

Further advantages, features and details of the present invention result from the subsequent description, in which different exemplary embodiments are described in greater detail on the basis of the drawing. In the figures,

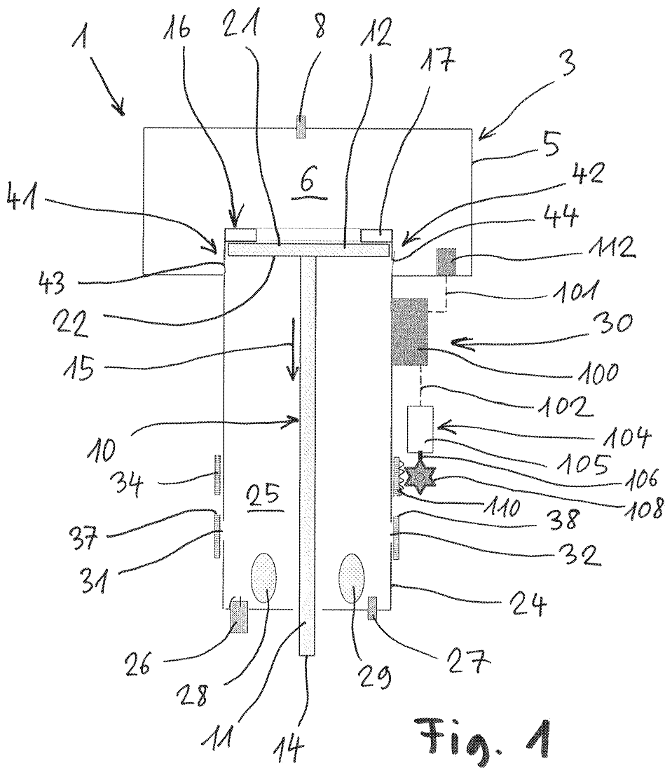

FIG. 1 shows a longitudinal section of a simplified illustration of a combustion-powered setting tool including a control device prior to an ignition in a prechamber;

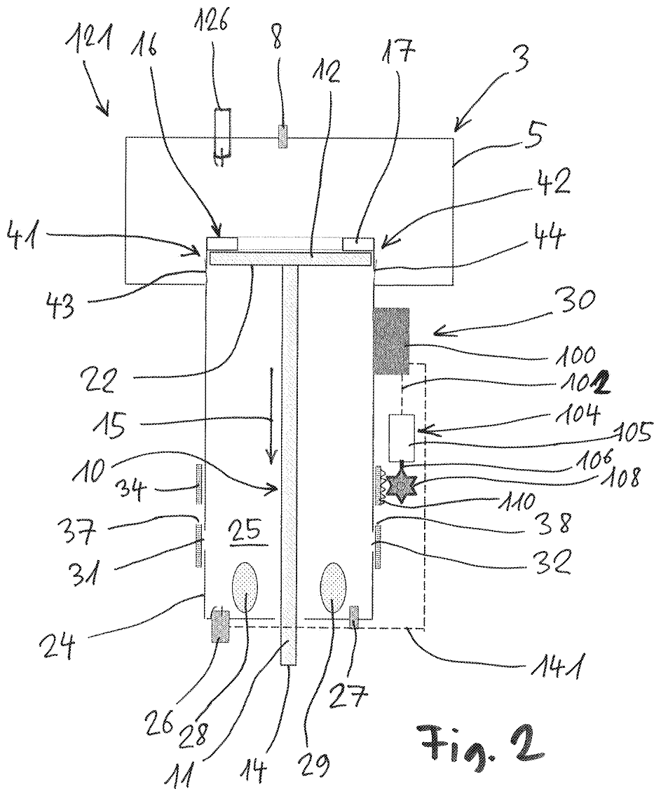

FIG. 2 shows a similar setting tool as in FIG. 1 in a longitudinal section, having a different control device, shortly before an ignition in a prechamber.

### EXEMPLARY EMBODIMENTS

FIGS. 1 and 2 show a setting tool 1 in a greatly simplified manner in a longitudinal section in different operating states. Setting tool 1 illustrated in FIGS. 1 and 2 can be operated by a combustion gas or by a vaporizable liquid fuel. Setting tool 1 includes a housing 3 having a main cylinder 5, which delimits a main combustion chamber 6. Gas and/or air can be supplied to main combustion chamber 6 via an inlet device 8.

In FIGS. 1 and 2, a drive piston 10 is guided moveably back and forth in the downward and upward directions in housing 3 of setting tool 1. Drive piston 10 includes a piston rod 11, which emanates from a piston head 12. A setting end 14 of piston rod 11 facing away from piston head 12 is situated in a bolt guide (not shown), which serves the purpose of guiding fastening elements which are also referred to as bolts.

The bolt guide including piston rod 11 of drive piston 10 situated therein is also referred to as a setting mechanism. Via the setting mechanism, a fastening element such as a nail, bolt or the like can be driven into a substrate (not shown). Before setting the fastening element, setting tool 1 is pressed by its bolt guide against the substrate, and is triggered. For example, a switch (not shown), which is also referred to as a trigger switch, serves to trigger a setting procedure. The switch, for example, is provided at a handlebar of setting tool 1 (also not shown).

In FIGS. 1 and 2, a setting direction is indicated by an arrow 15. When setting the fastening elements, drive piston 10 is greatly accelerated by piston rod 11 in setting direction 15 to drive the fastening element into the substrate. During the setting procedure, drive piston 10 is moved from its initial position shown in FIGS. 1 and 2, which corresponds to a top dead center, into an end position, which corresponds to a bottom dead center.

A movement of drive piston 10, in FIGS. 1 and 2 in the upward direction, is limited by a piston stop 16 fixedly joined with the cylinder. Piston stop 16 defines the top dead center of drive piston 10. Piston stop 16 may be combined with a magnetic device 17. Magnetic device 17, for example, serves to keep drive piston 10 by a predetermined holding force in its initial position shown in FIGS. 1 and 2.

A movement of drive piston 10 in the downward direction is limited by one or a plurality of stops and/or damping elements 28, 29. Stop and/or damping elements 28, 29 are configured as a buffer, for example.

Piston head 12 includes a first piston surface 21, which faces main combustion chamber 6. A second piston surface 22, which is facing away from main combustion chamber 6, delimits a prechamber 25 in a prechamber cylinder 24. Prechamber cylinder 24 is part of housing 3 of setting tool 1.

Prechamber 25 represents a pre-combustion chamber, to which an ignition device 26 and an inlet device 27 are assigned. Moreover, stop and/or damping elements 28, 29 are situated in prechamber 25. Via inlet device 27, a fuel-air mixture is supplied to prechamber or pre-combustion chamber 25, which is ignited in prechamber 25 with the aid of ignition device 26.

Prechamber cylinder 24 includes two passage openings 31, 32, which, for example, enable the discharge of exhaust gases from prechamber 25. Passage openings 31, 32 are closeable on demand by a control device 30. Control device 30 includes a control sleeve 34, which has two passage openings 37, 38.

If passage openings 37, 38 of control sleeve 34 are positioned to overlap with passage openings 31, 32, then passage openings 31, 32 are open. In FIGS. 1 and 2, passage openings 31, 32 are closed by control sleeve 34. Control sleeve 34 substantially has the shape of a straight circular cylinder jacket and in FIGS. 1 and 2 is moveable in the upward and downward directions.

Two or a plurality of overflow openings 41, 42 are provided between prechamber 25 and main combustion chamber 6. Respectively one valve device 43, 44 is assigned to overflow opening 41, 42. Valve devices 43, 44, for example, may be valve flaps, which open as a function of pressure, to enable the passage of the fuel-air mixture from prechamber 25 into main combustion chamber 6. In FIGS. 1 and 2, valve devices 43, 44 are closed.

The exemplary embodiments of setting tool 1; 121 illustrated in FIGS. 1 and 2 for the representation of control device 30 include an electronic controller 100. A control line 102 connects electronic controller 100 in terms of control to an electric actuator 104. Electric actuator 104 includes an electric motor 105 having a shaft 106. At an end of shaft 106 facing away from electric motor 105, a gear wheel 108 is indicated, which can be rotatably actuated by electric motor 105.

Gear wheel 108 meshes with a toothing 110, which is configured as a straight toothing. For example, toothing 110 can be configured at a toothed rod provided at the outside of control sleeve 34. When gear wheel 108 rotates counterclockwise, control sleeve 34 in FIGS. 1 and 2 moves in the downward direction, thus, in setting direction 15. When gear wheel 108 rotates clockwise, control sleeve 34 in FIGS. 1 and 2 moves in the upward direction, thus, against setting direction 15.

Electric motor 105 of electric actuator 104 may be a linear motor, for example. Instead of electric motor 105, electric actuator 104 may also include a different actuator, for example a piezo actuator. Different from the illustrations, control sleeve 34 for opening and closing passage openings 31, 32 of prechamber 25 can also be differently moved, for example twisted. The movement of control sleeve 34 can occur in any manner by applying a voltage.

For setting tool 1 illustrated in FIG. 1, a sensor device 112 is assigned to main combustion chamber 6. Sensor device 112 is connected in terms of control to the electronic controller of control device 30 via a control line 101. Sensor device 112 includes a pressure sensor, by which the pressure in main combustion chamber 6 is detected. When operating setting tool 1, sensor device 112 issues a signal, which is processed in electronic controller 100.

Electronic controller 100 can have further sensor inputs which are connected to further sensor devices (not shown). The further sensor devices may detect, for example, an ambient pressure or a pressure in prechamber 25. Alternatively or additionally, the further sensor devices may detect an acceleration and/or a temperature in different locations during operation of setting tool 1.

Moreover, the electronic controller advantageously includes a user interface. Via this user interface, a user of setting tool 1 can individually set the desired power for operating setting tool 1. With the aid of electronic controller 100, inter alia on the basis of the sensor data and user data, the following processes are controlled during operation of setting tool 1: an electronic control of a dosing amount, a control of ignition device 26 in prechamber 25 and/or of a further ignition device (not shown in FIG. 1), which may be assigned to main combustion chamber 6. Moreover, a not-shown ventilator for forming a mixture prior to combustion and/or for flushing is controlled after combustion by electronic controller 100.

With the aid of electric actuator 104, an effective passage cross section in passage openings 31, 32 of prechamber 25 may be infinitely variably adjusted in a simple manner via control sleeve 34. Particularly advantageously, a power setting or power adjustment by the user is enabled by the flexible control of the passage cross section. If the user of setting tool 1 chooses a low power setting, the prechamber ventilation only opens partially, later or not at all. This results in that when operating setting tool 1, an air cushion or a cushion of combustion gases is built up in prechamber 25. This cushion enables that drive piston 10 can be slowed in a significantly more gentle manner than slowing drive piston 10 suddenly, when the drive piston impacts stops and/or damping elements 28, 29 in prechamber 25. As a result, the wear of the tool can be reduced and the lifespan of the tool can be extended.

With the aid of electric actuator 104, the closing and release of passage openings 31, 32 of prechamber 25 can be controlled via electronic controller 100 in a simple manner as a function of the ambient air temperature and the ambient pressure. For both mentioned parameters, the density of air or of the fuel-air mixture changes prior to combustion in prechamber 25 and in main combustion chamber 6. This influences the combustion chamber pressure in main combustion chamber 6. In order to ensure constant power in a simple manner, the effective passage cross section of passage openings 31, 32 can be adapted.

For setting tool 121 illustrated in FIG. 2, it is illustrated that a further ignition device 126 can be assigned to main combustion chamber 6. Via further ignition device 126, a gas mixture can be ignited in main combustion chamber 6 independent from whether an ignition already has occurred in prechamber 25. In so doing, further operating modes of setting tool 121 become possible.

Different from setting tool 1 shown in FIG. 1, a control line 141 is provided for setting tool 121 shown in FIG. 2, which connects electronic controller 100 of control device 30 to ignition device 26 of prechamber 25. As a result, a time-oriented sequential control of the prechamber ventilation is enabled in a simple manner. In this instance, the opening and closing of passage openings 31, 32 of prechamber 25 by control sleeve 34, for example, is triggered after a specific period of time has elapsed after the ignition in the prechamber.

For example, electronic controller 100 measures a time interval which begins with the ignition in the prechamber. After the previously set time interval has elapsed, passage openings 31, 32 of prechamber 25 are released by control sleeve 34 via electric actuator 104, that is the passage openings are opened. Inter alia, this has the advantage that a sensor device (112 in FIG. 1) can be omitted.

1. A combustion-powered setting tool for driving fastening elements into a substrate, comprising at least one main combustion chamber for a fuel; a drive piston actuatable by expandable gases from the at least one main combustion chamber in a setting direction; and a prechamber, to which an ignition device is assigned and in which a pressure acting on the at least one main combustion chamber is buildable prior to ignition of a fuel-air mixture in the at least one main combustion chamber, wherein the prechamber is connected or connectable to surroundings of the prechamber by at least one passage opening, which is closeable by a control device, wherein the control device comprises an electronic controller.

2. The combustion-powered setting tool as recited in claim 1, wherein the electronic controller is connected to an electric actuator.

3. The combustion-powered setting tool as recited in claim 2, wherein the electric actuator comprises an electric motor.

4. The combustion-powered setting tool as recited in claim 2, wherein the electric actuator is mechanically coupled to a control sleeve.

5. The combustion-powered setting tool as recited in claim 4, wherein the control sleeve has a toothing, which is coupled via a gear wheel to the electric actuator.

6. The combustion-powered setting tool as recited in claim 4, wherein the control sleeve is configured to be moveable in relation to the at least one passage opening of the prechamber so that the at least one passage opening of the prechamber is released or closed by the control sleeve via the electronic controller by the electronic actuator.

7. The combustion-powered setting tool as recited in claim 1, wherein the electronic controller is connected to at least one sensor device, which is assigned to the at least one main combustion chamber.

8. The combustion-powered setting tool as recited in claim 2, wherein the electronic controller is connected to the ignition device.

9. A method for operating the combustion-powered setting tool according to claim 1, the method comprising controlling the at least one passage opening of the prechamber as a function of ignition time and/or a sensor.

10. A control device comprising an electronic controller, an electric actuator and/or a control sleeve, for a setting tool.

11. The combustion-powered setting tool as recited in claim 3, wherein the electric actuator is mechanically coupled to a control sleeve.

12. The combustion-powered setting tool as recited in claim 11, wherein the control sleeve has a toothing, which is coupled via a gear wheel to the electric actuator.

13. The combustion-powered setting tool as recited in claim 5, wherein the control sleeve is configured to be moveable in relation to the passage opening of the prechamber so that the passage opening of the prechamber is released or closed by the control sleeve via the electronic controller by the electronic actuator.

14. The combustion-powered setting tool as recited in claim 11, wherein the control sleeve is configured to be moveable in relation to the passage opening of the prechamber so that the passage opening of the prechamber is released or closed by the control sleeve via the electronic controller by the electronic actuator.

15. The combustion-powered setting tool as recited in claim 12, wherein the control sleeve is configured to be moveable in relation to the passage opening of the prechamber so that the passage opening of the prechamber is released or closed by the control sleeve via the electronic controller by the electronic actuator.

16. The combustion-powered setting tool as recited in claim 2, wherein the electronic controller is connected to at least one sensor device, which is assigned to the at least one main combustion chamber.

17. The combustion-powered setting tool as recited in claim 3, wherein the electronic controller is connected to at least one sensor device, which is assigned to the at least one main combustion chamber.

18. The combustion-powered setting tool as recited in claim 4, wherein the electronic controller is connected to at least one sensor device, which is assigned to the at least one main combustion chamber.

19. The combustion-powered setting tool as recited in claim 5, wherein the electronic controller is connected to at least one sensor device, which is assigned to the at least one main combustion chamber.

20. The combustion-powered setting tool as recited in claim 6, wherein the electronic controller is connected to at least one sensor device, which is assigned to the at least one main combustion chamber.
